(19) United States
(12) Patent Application Publication
(10) Pub. No.: US 2015/0293143 A1
(43) Pub. Date: Oct. 15, 2015

(54) Feature Extraction from Human Gaiting Patterns using Principal Component Analysis and Multivariate Empirical Mode Decomposition

(71) Applicant: Stanley Kim, San Diego, CA (US)

(72) Inventors: JOHN KAR-KIN ZAO, Hsinchu (TW); CHIH-KAI LU, Hsinchu (TW)

(73) Assignee: NATIONAL CHIAO TUNG UNIVERSITY, Hsinchu (TW)

(21) Appl. No.: 14/337,234

(22) Filed: Jul. 22, 2014

Related U.S. Application Data
(60) Provisional application No. 61/856,704, filed on Jul. 21, 2013.

(51) Int. Cl. G01P 15/16; G01C 22/00; G01B 21/00

(52) U.S. Cl. CPC G01P 15/165; G01B 21/00; G01C 22/006

(57) ABSTRACT

The present invention, in some embodiments thereof, relates to a technique for extracting one or more features of a person's gait from acceleration and velocity measurements collected by motion sensors associated with the person.

### CROSS-REFERENCE TO RELATED APPLICATION

This application claims the priority benefit of U.S. Provisional Application serial No. 61/856704, filed on Jul. 21, 2013. The entirety of the above-mentioned patent application is hereby incorporated by reference herein and made a part of this specification

### FIELD OF INVENTION

The present invention, in some embodiments thereof, relates to a technique for extracting one or more features of a person's gait from acceleration and velocity measurements collected by motion sensors associated with the person.

### SUMMARY OF INVENTION

This invention relates to a signal processing technique for extracting gaiting cycles—in the form of amplitude and frequency modulated sinusoids—and stepping impact impulses from acceleration and velocity measurements collected by the motion sensors. Optionally, the technique of the present invention further includes parameterization mechanisms that measure time-varying amplitudes, frequencies and relative phases of these characteristic signals, to extract features of the gaiting cycles, such as step size, stepping force, body wavering, and gaiting speed. These features may be used to distinguish normal vs. abnormal gaiting behaviors in lieu of the actual motion waveforms and can be used in detection, classification and compressed representation of human gaiting patterns. The technique of the present invention is robust and can produce correct results regardless of the orientation of the motion sensor. The technique is also computationally efficient and can thus be implemented on mobile phones or advanced wireless sensors.

In some embodiments of the present invention, an input is received in form of data indicative of three-dimensional (3D) linear acceleration and angular velocity. Principal component analysis (PCA) is first applied as a pre-processing step to whiten and re-orientate the input signals in order that the input signals become unit-variant and orthogonal to one another. This enables simplified multivariate empirical mode decomposition to be applied onto these signals.

Multivariate empirical mode decomposition (MEMD) is then used to decompose the principal components of both linear acceleration and angular velocity into their sinusoid-like intrinsic mode functions (IMFs). Different IMFs are selected based on their signal power and then combined to form the waveforms of gaiting cycles and stepping impulses. Optionally, instantaneous frequencies as well as the peak and zero-crossing points of these waveforms are calculated and used as feature parameters to characterize human gaiting behaviors.

### DESCRIPTION OF DRAWINGS

FIG. 1 shows the signal processing and parameterization pipeline that deduces feature parameters from the 3D linear acceleration and the 3D angular velocity of human gaiting behaviors.

FIG. 2 shows the signal flow and operation sequence to decompose 3D linear acceleration and angular velocity into their intrinsic mode functions (IMFs) using principal component analysis (PCA) and multivariate empirical mode decomposition (MEMD).

FIG. 3 shows the workflow to construct the Characteristic Waveforms of gaiting behaviors including those of Gaiting Cycles, Gaiting Trends, Stepping Impacts and Gaiting Perturbation from the IMFs of the principal components of 3D linear acceleration and 3D angular velocity.

FIG. 4 illustrates the Gaussian curve fitting technique used to select the intrinsic mode functions (IMFs) for constructing the Characteristic Waveforms of Stepping Impacts and Gaiting Perturbations.

FIG. 5 shows the One-sided Gaussian fitting over IMF power distribution for constructing Gaiting Perturbation waveforms.

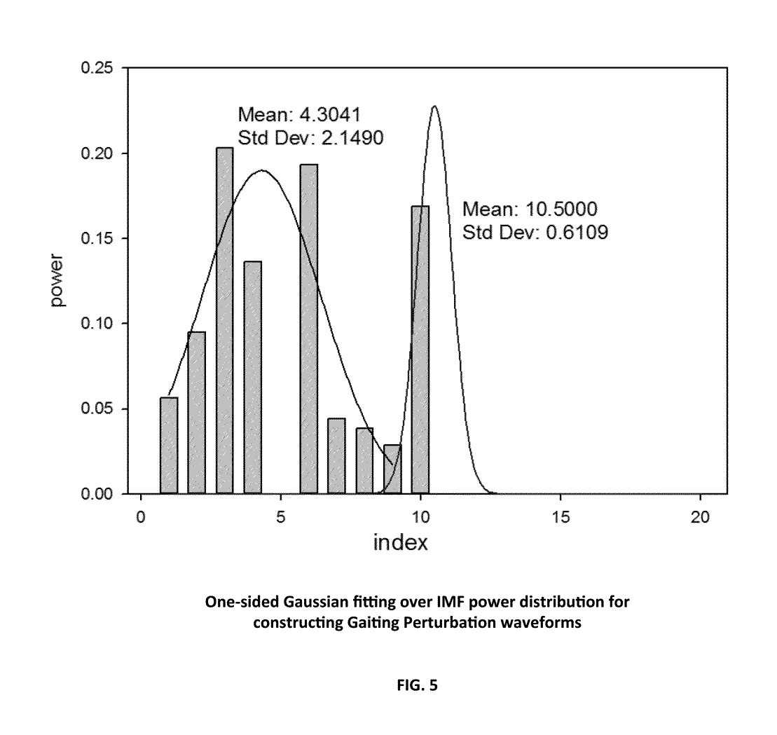

FIG. 6 shows the workflow to deduce feature parameters from the Characteristic Waveforms of Gaiting Cycles.

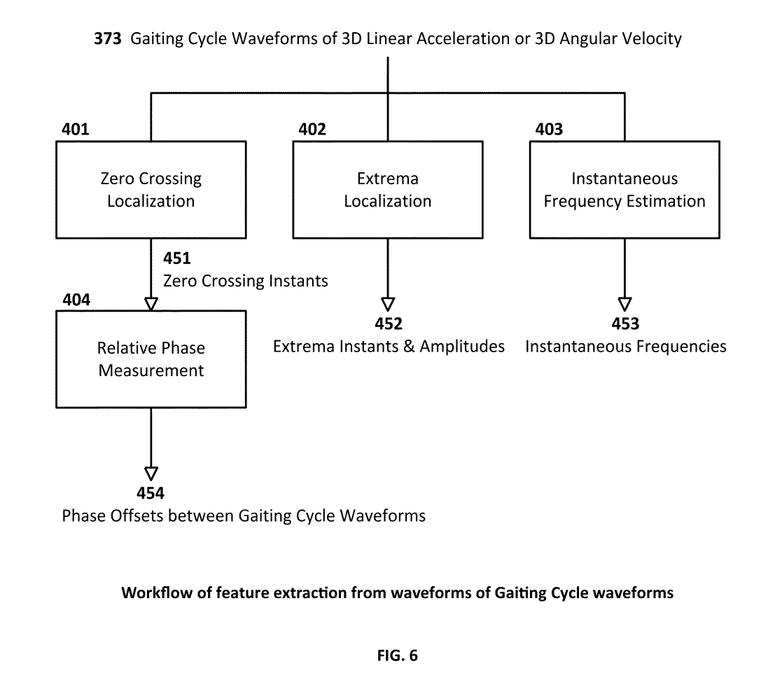

FIG. 7 shows the workflow of feature extraction from Gaiting Impact waveform.

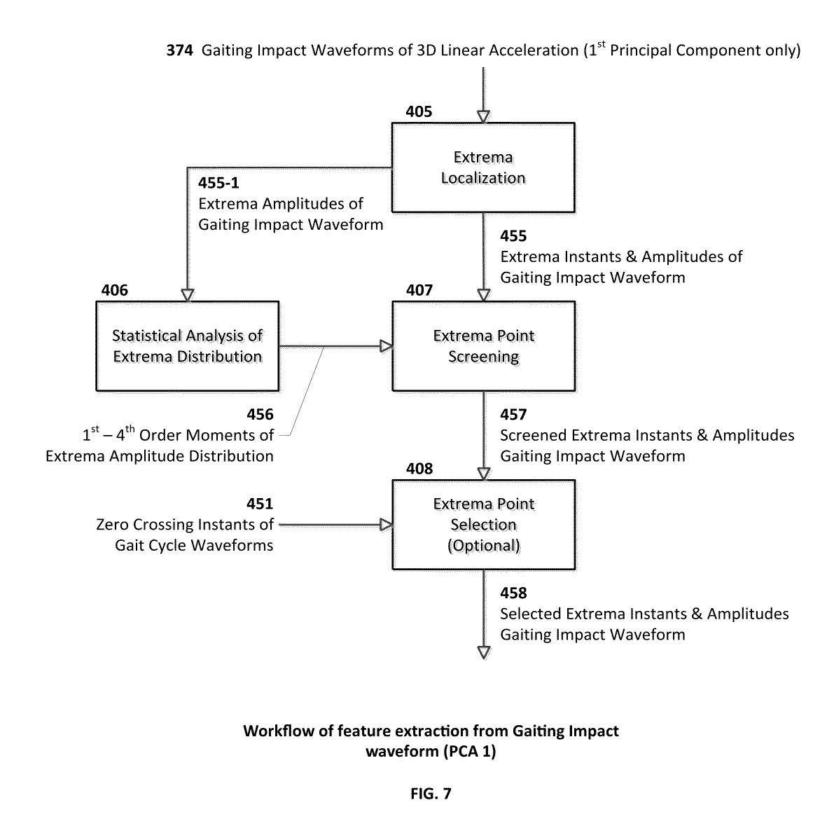

FIG. 8 illustrates the amplitude distribution of extrema points of Gaiting Impact waveform

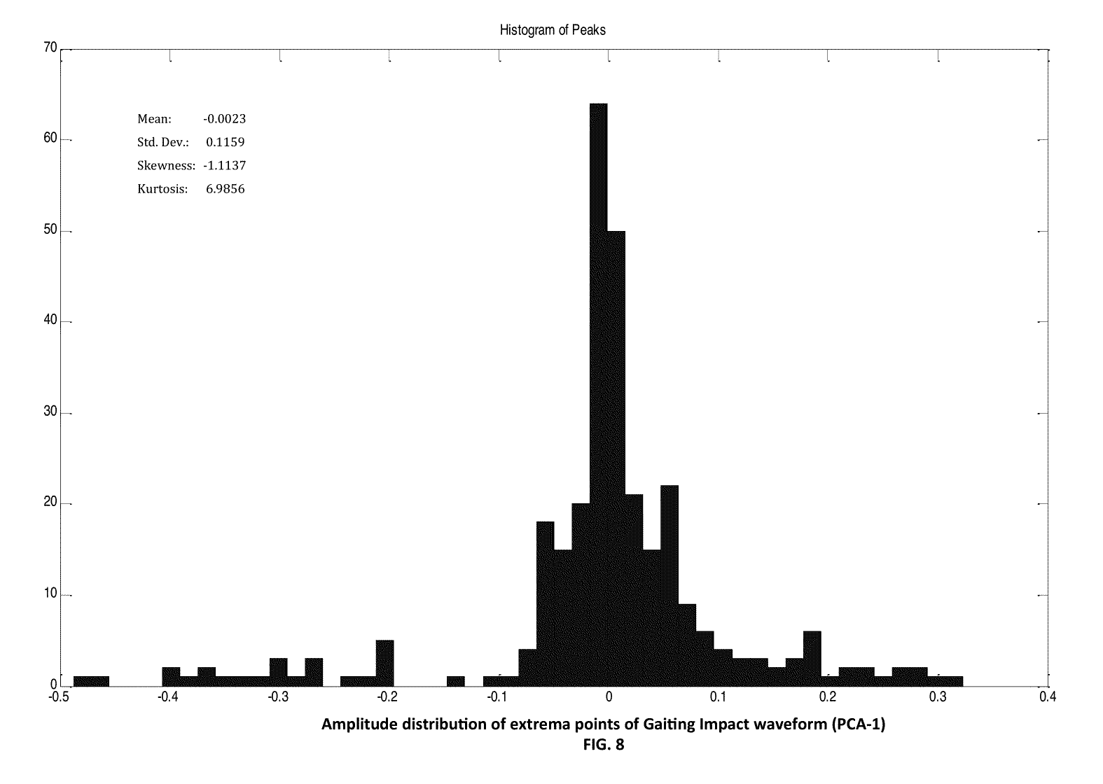

FIG. 9 shows screened extrema points of Gaiting Impact waveform (PCA-1)

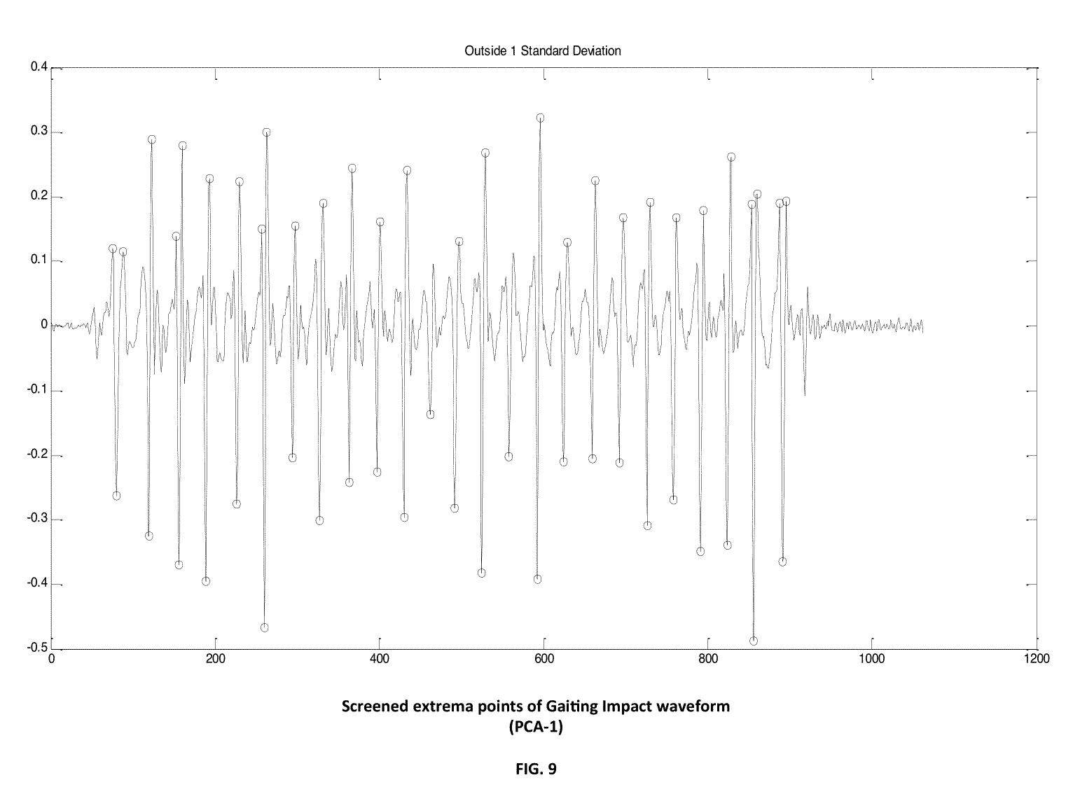

FIG. 10 shows selected extrema points of Gaiting Impact waveform (PCA-1)

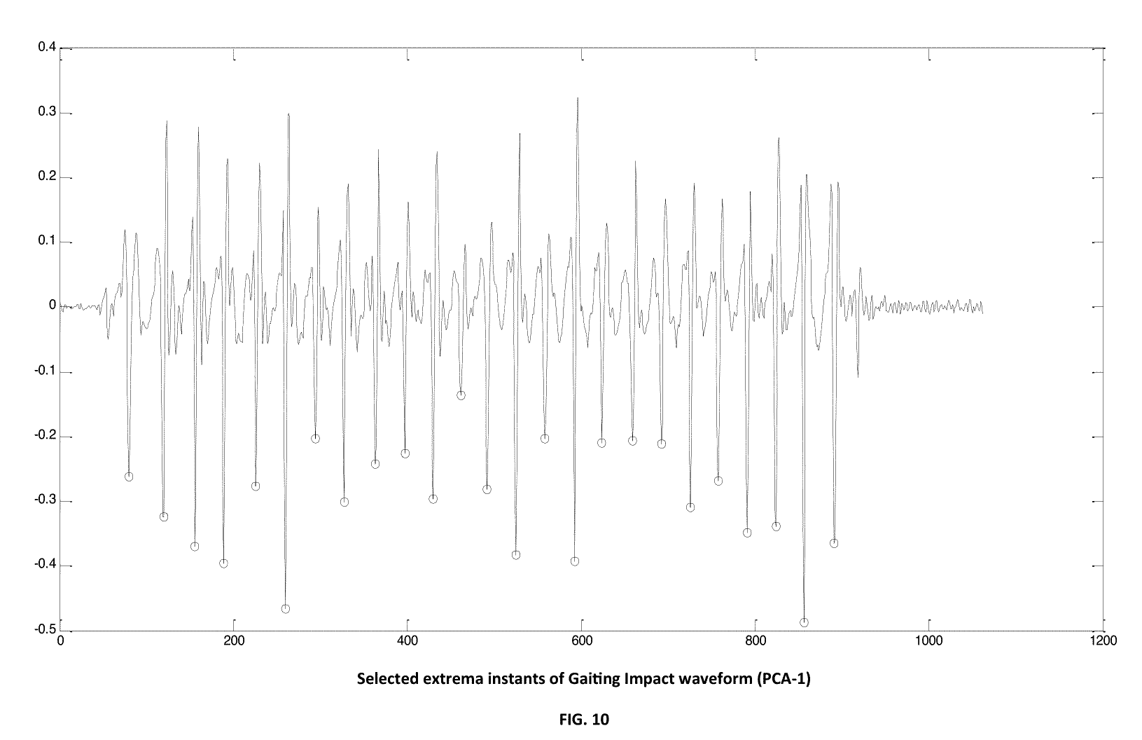

FIG. 11 shows the original waveforms of 3D linear acceleration in body coordinates.

FIG. 12-FIG. 18 display the waveforms and the feature points of the gaiting patterns of a healthy user. FIG. 12 shows the power profile of the IMF components of 3D linear acceleration caused by normal human gaiting behaviors.

FIG. 13 displays the histograms of IMF power distribution of 3D linear acceleration of normal human gait

FIG. 14 shows the Characteristic Waveforms of Gaiting Cycles and Stepping Impacts.

FIG. 15 shows the instants and amplitudes of extrema points of Gaiting Impact waveform

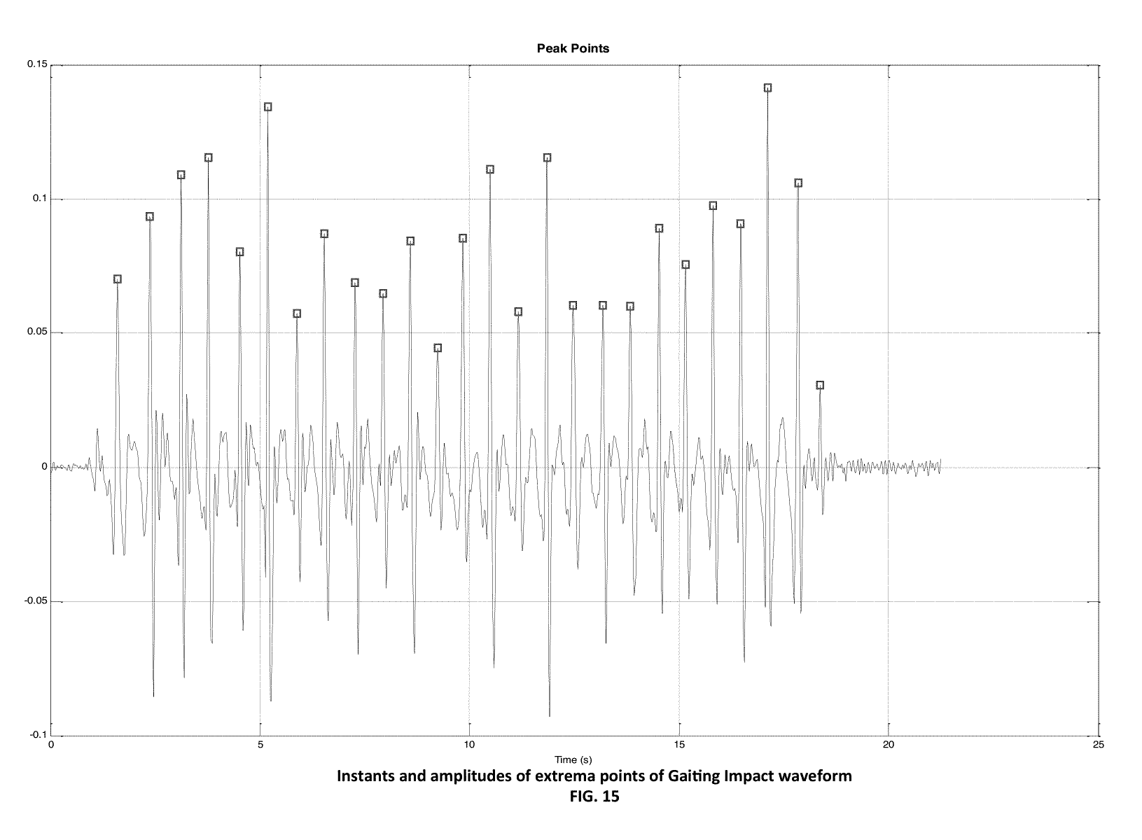

FIG. 16 shows the peak points and the envelops of the Gaiting Cycles of the principal components of 3D linear accelerations.

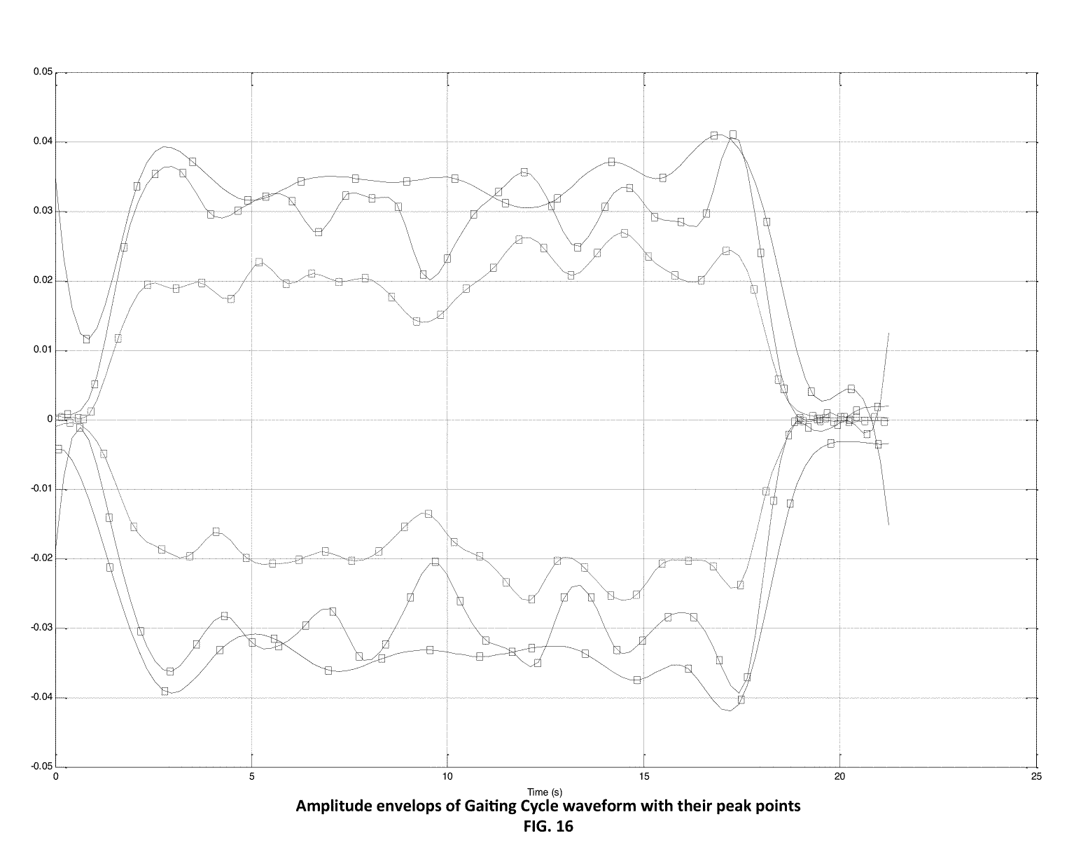

FIG. 17 and FIG. 18 show the instantaneous frequencies and relative phases of the Gaiting Cycles of the same principal components. FIG. 17 shows Instantaneous frequencies of Gaiting Cycle waveforms.

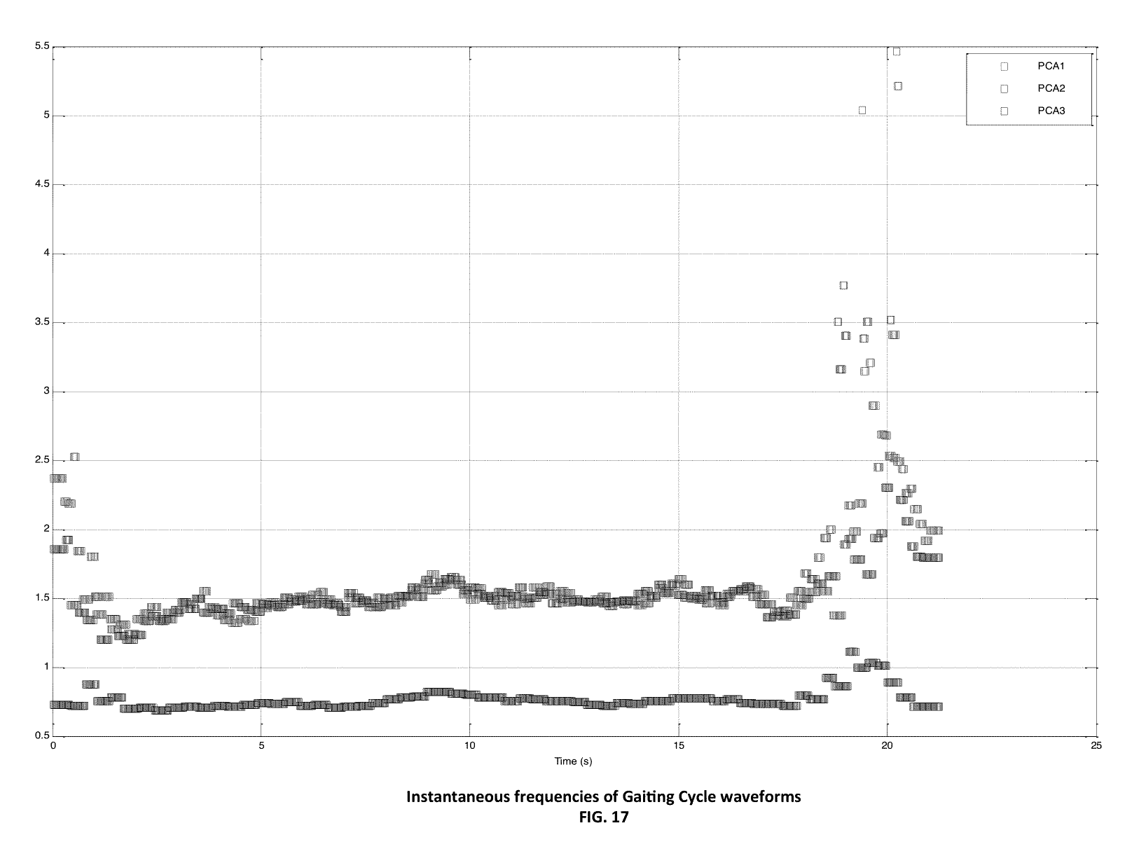

FIG. 18 shows the relative phases between Gaiting Cycle waveforms

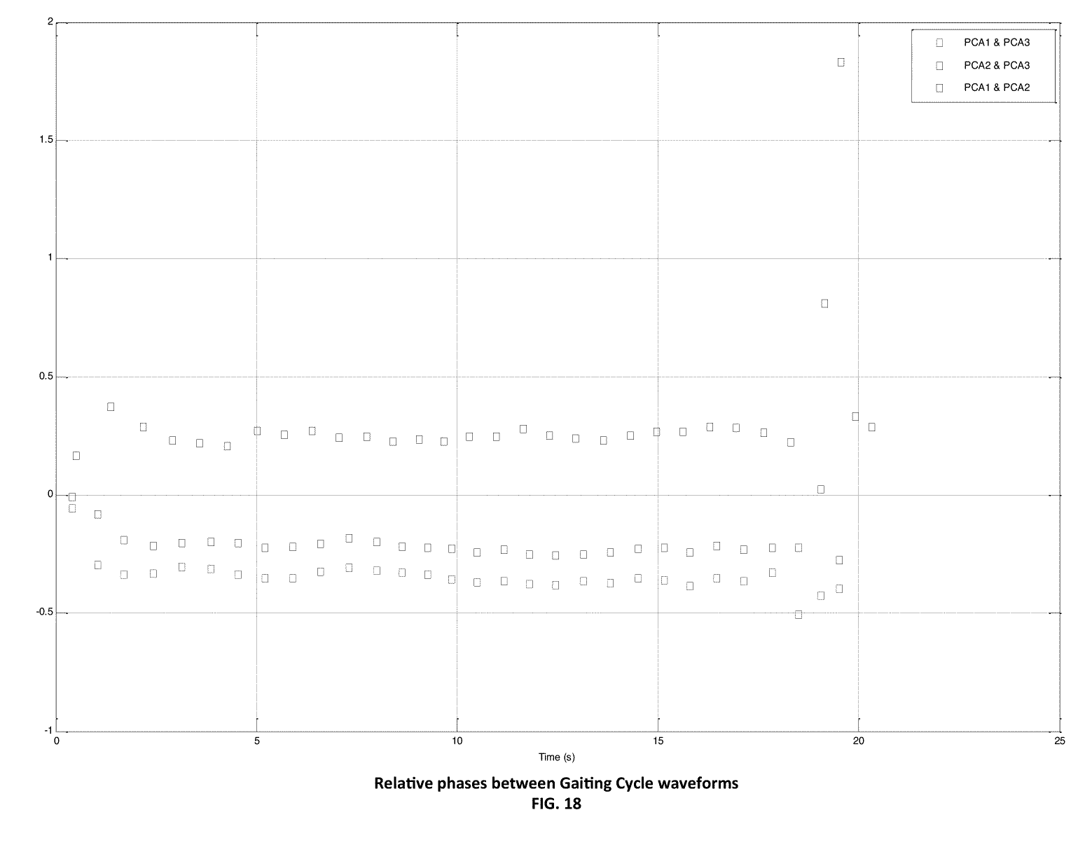

### DETAILED DESCRIPTION OF INVENTION

### 1. Overview

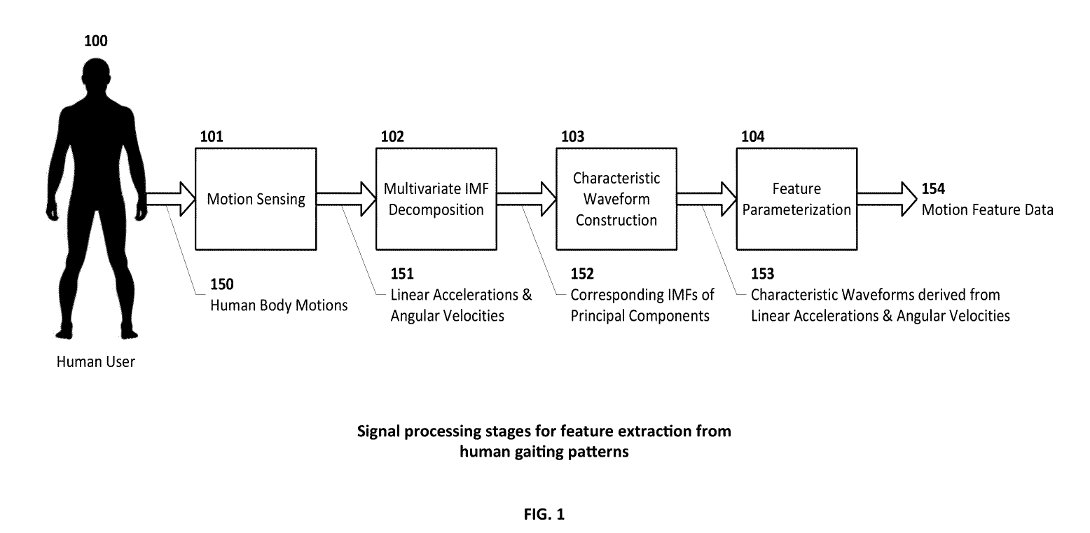

The invented gaiting feature extraction method consists of three stages: (1) Multivariate Implicit Mode Function (IMF) Decomposition 102, (2) Characteristic Waveform Construction 103 and (3) Feature Parameterization 104. FIG. 1 shows the signal flows and the processing stages of the invented method.

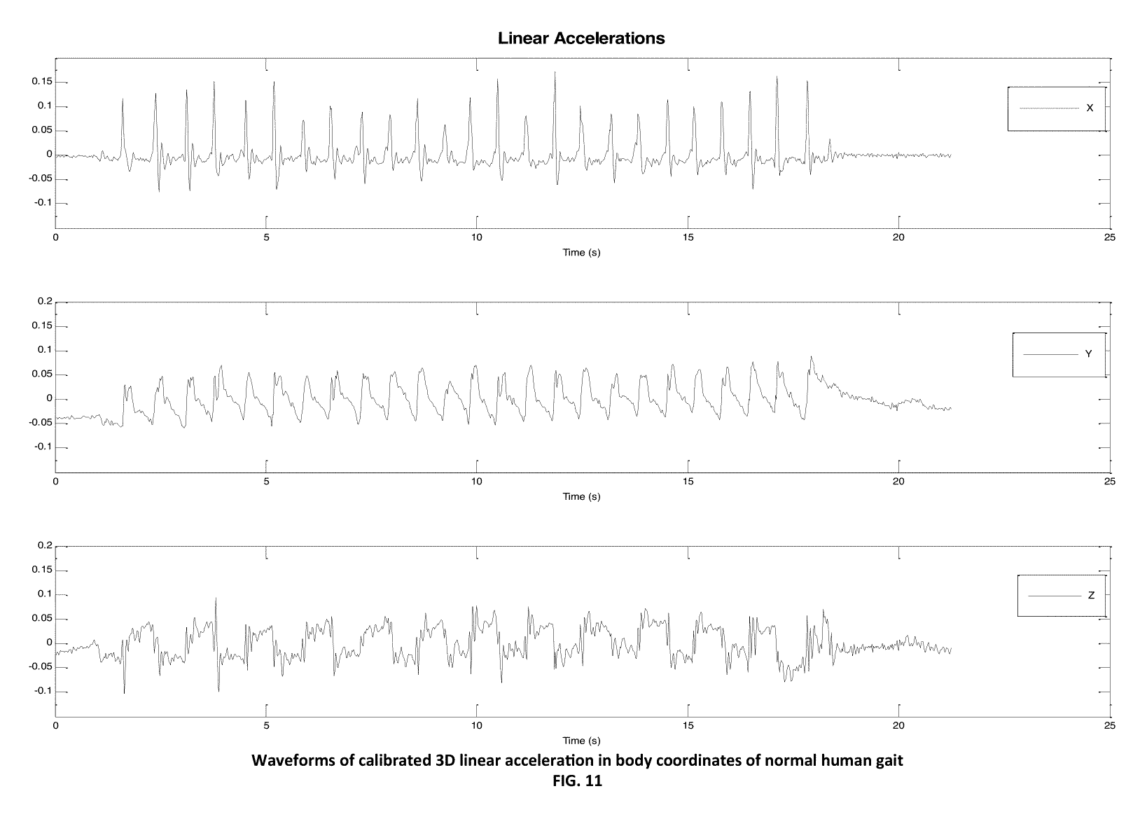

Any kind of wearable motion sensors 101 that are capable of yielding measured data indicative of three dimensional linear acceleration and angular velocity of body motions can be used to provide input signals 150 to the feature extraction process. Sensors that measure angular acceleration or changes in Euler angles (row, pitch and yaw) can be used, and the data output therefrom can be used to calculate angular velocity. Raw acceleration and velocity measurements from microelectromechanical (MEMS) motion sensors can be accepted if they are measured with respect to the world/earth-based coordinate system. Nonetheless, calibrated linear acceleration and angular velocity in the body or sensor coordinates that are processed by Kalman filters and motion data fusion algorithms are preferred in order to have ensure high signal-to-noise ratios. Though high data sampling rates (50-100 samples/second) are preferred as they can improve the resolution and accuracy of extracted feature parameters, the inventors have obtained accurate results with input sampled at 10 samples/second. FIG. 11 shows the waveforms of three-dimensional (3D) linear acceleration in the body coordinates, which were measured at the rate of 50 sample/second and calibrated using Kalman filters and data fusion algorithms.

For the purpose of capturing the measurements of full body motions, users should wear the motion sensor on their torsos instead of their limbs so as to diminish the interference of limb movements. However, if monitoring of limb movements is intended then the motion sensors should be attached to the limbs concerned.

The sampled and digitized three-dimensional (3D) linear acceleration and three-dimensional (3D) angular velocity 151 are processed first in the Multivariate Implicit Mode Function (IMF) Decomposition stage 102, which will be described in more detail below. A total of six input signal components are fed into this stage. This processing stage yields a maximum of six sets of IMFs, each set corresponding to a principal component with significant signal power. Up to three IMF sets may be derived from the 3D linear acceleration; similarly, up to three IMF sets may be derived from the 3D angular velocity. All IMFs have the same sampling rates as the input signals.

The Characteristic Waveform Extraction stage 103 (which will be described in more detail below) manipulates each set of IMFs separately with identical signal processing steps; however, the process parameters may be set to different values for each set of IMFs. Selected IMFs of each principal component are combined to yield the following three groups of characteristic waveforms:
The waveform of Gaiting Cycle—which is a sinusoidal waveform with time-varying amplitude and frequency corresponds to the basic gaiting cycles of the human user. Each cycle of the waveform may correspond to a “half step” caused by the movement of one leg or a “full step” caused by the movement of both legs. The “full-step” cycles usually correspond to the oscillatory side-movements of user's body when he/she moves his/her feet forward. The “half-step” cycles, on the other hand, correspond to the up-down or forward movement of his/her body when he/she moves each of her feet.
The waveform of Gaiting Impacts—which is a quasi-periodic waveform with sharp peaks, each of which corresponds to the acceleration or deceleration caused by the impact of user's feet with the walking surface. The noisy fluctuations of the waveform also show the acceleration or deceleration caused by the user's limb movements.
The waveform of Gaiting Perturbation—which is a low-frequency quasi-periodic waveform that shows the wavering of user's body between steps. Significant perturbation may reveal a pathological condition of user's gaiting behaviors.

The waveforms produced by the Characteristic Waveform Extraction stage 103 are then analyzed separately in the Feature Parameterization stage 104. In this stage, the properties of each waveform such as its time-varying amplitude and frequency as well as the relations among these waveforms such as their relative phases can be measured and treated as feature parameters. These parameters can be used in detection, classification and compressed representation of the gaiting patterns in lieu of actual motion waveforms.

2. Multivariate Implicit Mode Function Decomposition using Principal Component Analysis (PCA) and Multivariate Empirical Mode Decomposition (MEMD)

This processing stage 102 employs a novel combination of Principal Component Analysis (PCA) [as described in references 1 and 2] with Multivariate Empirical Mode Decomposition (MEMD) [as described in reference 3] in order to accomplish the following objectives: (1) eliminate the influence of arbitrary orientation of the motion sensor to the 3D linear acceleration and angular velocity inputs 151, (2) discard the input components that have significantly less signal power as they are less relevant to users' body motions, and (3) decompose compose the significant components of the input signals into corresponding sets of implicit mode functions (IMFs). Each of these sets contains the same number of IMFs. Furthermore, the corresponding IMFs in each of these sets occupy the same frequency bands that can be specified in terms of a bank of dyadic filters [as described in reference 4].

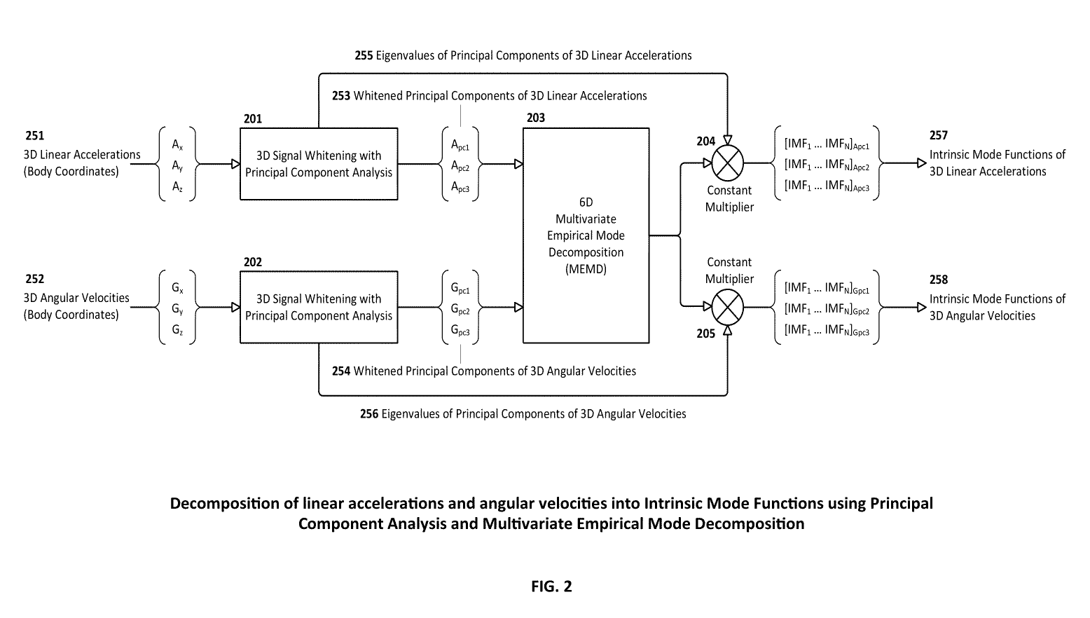

FIG. 2 shows the signal flows and operations of this processing stage. The 3D linear acceleration 251 and the 3D angular velocity 252 are subjected to separate signal whitening processes 201 and 202 based on Principal Component Analysis (PCA) such that the variance of all signals is equalized to unity. In the case that the 3D linear acceleration and 3D angular velocity are measured with respect to the world coordinates with reference to the true vertical direction then these inputs may skip the PCA process and can simply be normalized with respect to their signal power because this simpler process also reduce their variance to unity.

The signal whitening process can be described by the following formula. Let the input to the PCA process be a 3×N matrix X with N being the number of signal samples. PCA yields the positive eigenvalues λ₂, λ₂, λ₃ and the orthonormal eigenvectors w₁, w₂, w₃ of the covariance matrix of X. The whitened (uncorrelated and unit variant) principal components Z of X can be computed as

Z=Λ^{-1/2}W^{T}X with Λ^{def}diag [λ₁, λ₂, λ₃] and W ^{def}[w₁, w₂, w₃].

This PCA process produces the whitened principal components 253 and 254 of the 3D linear acceleration 251 and the 3D angular velocity 252 respectively. It also produces the positive eigenvalues λ₁, λ₂, λ₃ in 255 and 256 along with the principal components. If one or more of the eigenvalues are significantly smaller (by at least an order of magnitude) than the others then the corresponding principal component(s) may be discarded. The remaining ones are referred hereafter as the significant principal components.

The whitened principal components with significant eigenvalues 253 and 254 are then processed together using Multivariate Empirical Mode Decomposition (MEMD) 203. The unit-variance property of the whitened principal components enhances the ability of MEMD to separate each input signal into a set of implicit mode functions (IMFs) that occupy distinct frequency bands. Additional input of zero-mean white Gaussian noise can be injected to the MEMD process in order to reduce the “mode mixing” effect of MEMD [4]. Up to two Gaussian-noise inputs, each of which have up to ten percent (10%) of total input signal power can be added to this process. However, their corresponding IMFs shall be removed from the MEMD output.

In order to scale the IMFs to their actual amplitudes, the MEMD output shall be multiplied with the positive square-roots of the corresponding eigenvalues 255 and 256 by the constant multipliers 204 and 205. The corresponding sets of IMFs 257 and 258 of the significant principal components of the 3D linear acceleration and the 3D angular velocity respectively can be computed as the vector Y in the following equation:

Y=Λ^{1/2}Z=W^{T}X.

3. Characteristic Waveform Construction from Implicit Mode Functions

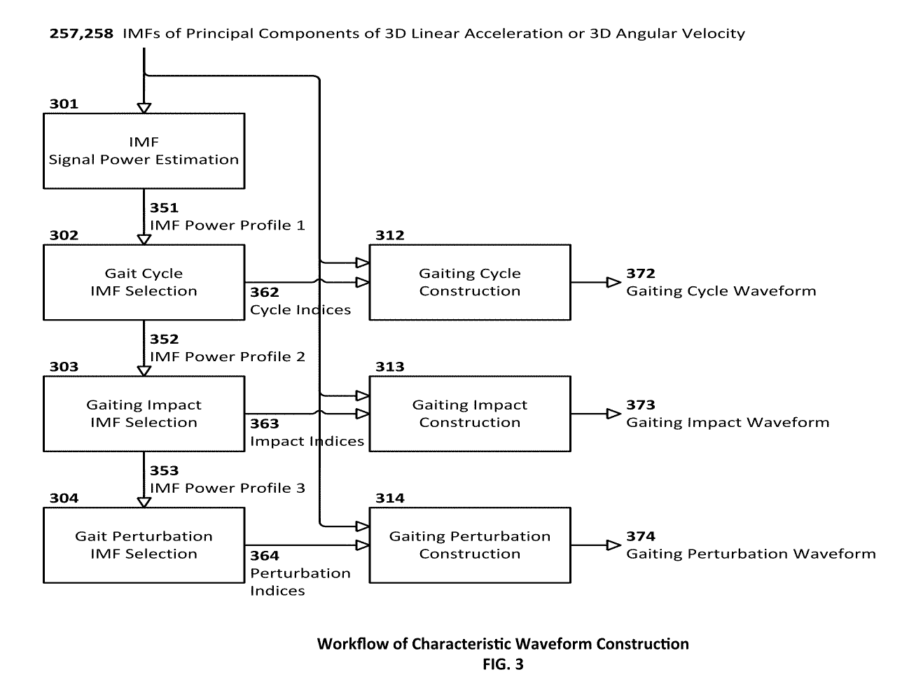

In each set of IMFs obtained from the previous stage 102, one or more IMFs from the significant principal components are combined to form the Characteristic Waveforms of the 3D linear acceleration and the 3D angular velocity. These Characteristic Waveforms carry important biophysical information of user's gaiting behaviors. This process is performed in the stage 103. FIG. 3 shows the sequential operation that produces three kinds of Characteristic Waveforms, which are referred to as (1) Gaiting Cycles, (2) Gaiting Impacts and (3) Gaiting Perturbation. The IMFs of each significant principle component of the 3D linear acceleration and the 3D angular velocity can produce a set of Characteristic Waveforms. The waveforms are then processed together in the Feature Parameterization stage 104 to yield the gaiting feature parameters.

The selection of IMFs for the construction of Characteristic Waveforms is based on the signal power of individual IMF. The signal power of each waveform is first calculated in 301. The selection process is then performed sequentially by the selection operations 302-304. Each operation removes the selected IMF(s) from the existing set of IMFs before passing the remaining sets (351-353) to the subsequent operations.

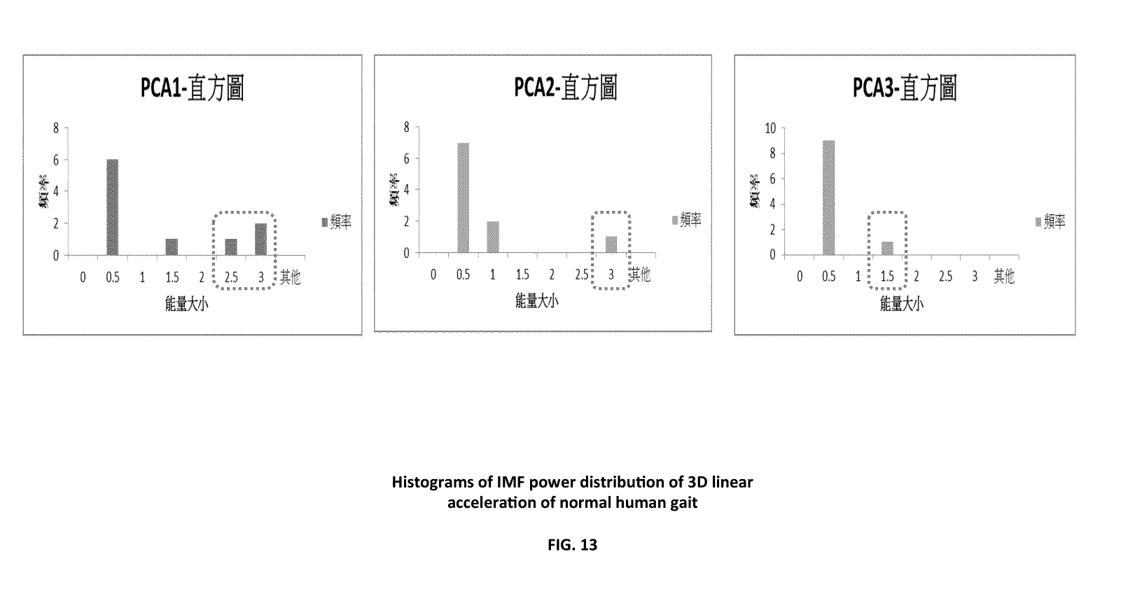

The distribution of IMF signal power is highly asymmetric or bi-modal. As shown in FIG. 13, each set of IMFs consists of a dominant cluster of low-power IMFs and a smaller cluster of significant higher-power IMFs. In the subsequent steps, the high-power IMFs shall be selected for the construction of the Gaiting Cycle and the Gaiting Impact waveforms while a few low-power IMFs shall be selected for the construction of the Gaiting Perturbation waveforms.

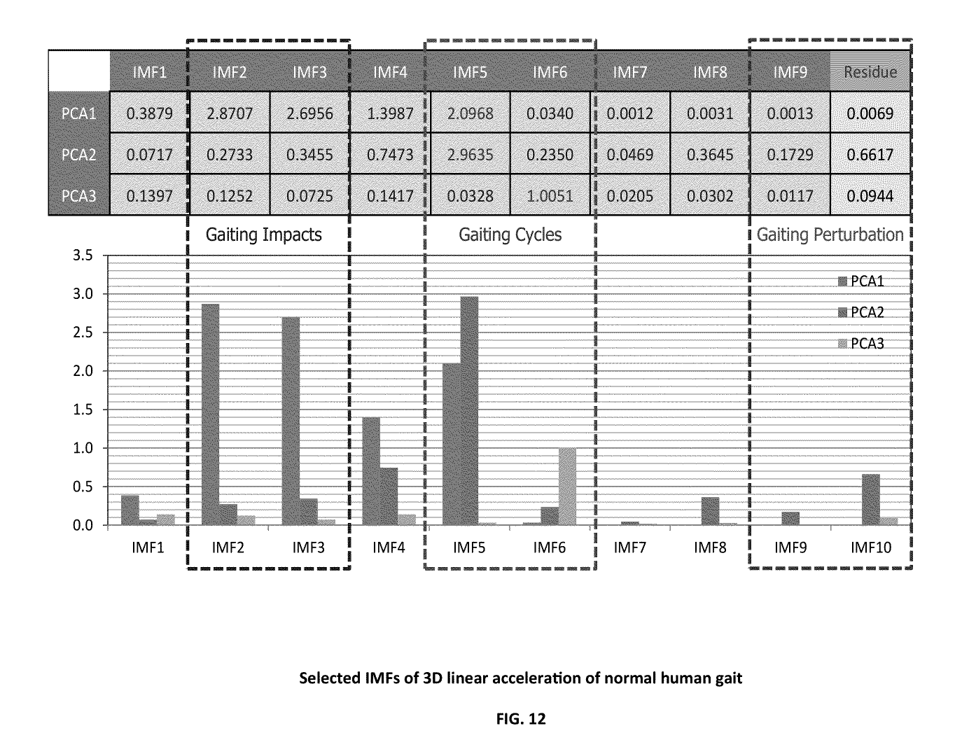

In the first step, the waveforms of Gaiting Cycles are constructed in 302 and 312 from the IMFs with the highest level of signal power such as those highlighted in FIG. 13. These high-power IMFs under different significant principal components tend to reside in two adjacent frequency bands that contain the “half-step” and “full-step” gaiting waveforms. Only those IMFs under each significant principal component are selected to form the Gaiting Cycle Waveforms. For example, among the IMFs in FIG. 12, only IMF5 of PCA1, IMF5 of PCA2 and IMF6 of PCA3 were selected. Note that IMF5 of PCA1 was merely the third most powerful IMF under PCA1. It was selected because first it resided in the high-power IMF cluster and it also resided in the frequency band that contained the most powerful IMF of PCA2 (IMF5) and in the adjacent frequency band that contained the most powerful IMF of PCA3 (IMF6). In 312, the IMFs in the higher-frequent band (such as the IMF5 of PCA1, PCA2 in the example) are combined to produce the “half-step” gaiting waveform while the IMFs in the lower-frequency band (such as the IMF6 of PCA3) are combined to produce the “full-step” gaiting waveform. The “half-step” and “full-step” gaiting waveforms are so called because they are frequency and phase locked to the physical movement of users' bodies. The “full-step” waveforms correspond to the oscillatory side-movements of user's body when he/she moves his/her feet forward. The “half-step” waveforms, on the other hand, correspond to the up-down or forward movement of his/her body when he/she moves each of her feet.

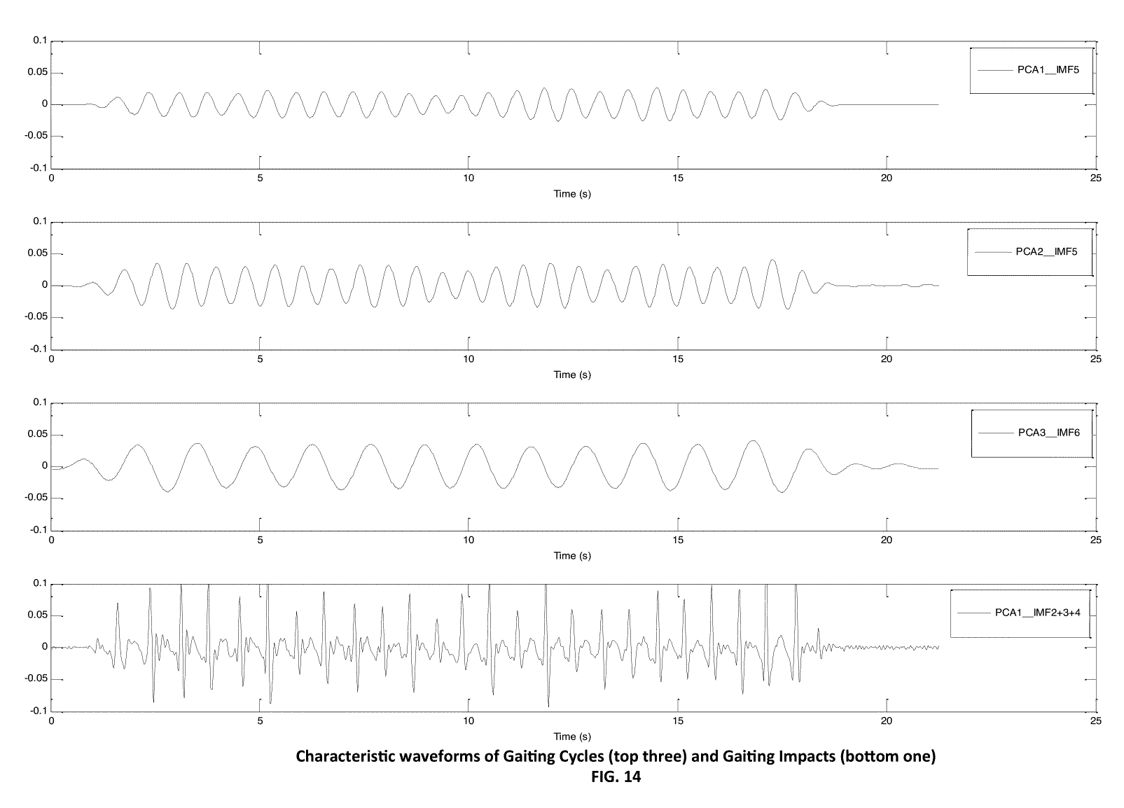

The top three waveforms displayed in FIG. 14 are the “half-step” and “full-step” Characteristic Waveforms constructed from the 3D linear acceleration waveforms shown in FIG. 11.

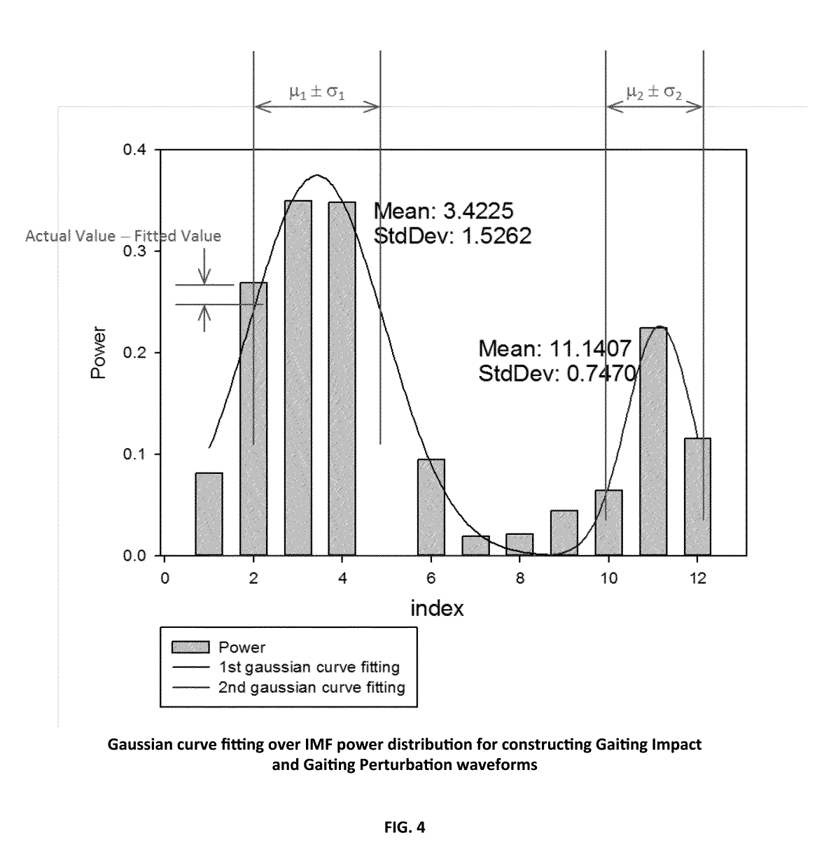

In the Second step, the waveforms of Gaiting Impacts are constructed in 303 and 313 from the IMFs selected from those remaining in the high-power cluster based on a profiling of their signal power. FIG. 4 illustrates the selection procedure performed in 303. First, a Gaussian curve (in black) is fitted through the high-power IMFs as they are arranged in the ascending order of their frequency bands.—Such an arrangement corresponds coarsely the frequency distribution of their signal power.—The mean μ₁ and the standard deviation σ₁ of the Gaussian distribution are calculated. Then, select the IMFs that lie within the main lobe of the Gaussian distribution. These are the IMFs with their indices lying between └μ₁−σ₁┘ and ┌μ₁+σ₁┐ where └ ┘ and ┌ ┐ denote the floor and the ceiling functions. The IMFs selected are then combined in 314 to produce the Gaiting Impact waveform. These Gaiting Impact Waveforms are composed of the IMFs with frequencies higher than the half-step and full-step gaiting waveforms; moreover, they clearly show the time and amplitudes of acceleration and deceleration caused by the impact of user's feet with the walking surface.

After the IMFs for producing the Gaiting Impact waveform have been selected, the signal power of all the IMFs are adjusted by subtracting the Gaussian-fitted signal power from their actual signal power as illustrated in FIG. 4. The adjusted profile of IMF signal power is passed through 353 for the construction of Gaiting Perturbation waveforms.

In the last step, the waveforms of Gaiting Perturbation are constructed in 305 and 315 from the IMFs that have their signal power falling in the main lobe of the residual Gaussian signal power distribution. Similar to the procedure described in [0041], a Gaussian curve (in navy blue) is fitted through the remaining IMFs as they are arranged according to the ascending order of their frequency bands. Then, the mean μ₂ and the standard deviation σ₂ of the Gaussian curve are calculated. Again, the IMFs with their indices lying between └μ₂−σ₂┘ and ┌μ₂+σ₂┐ are selected. The selected IMFs are combined in 315 to produce the Gaiting Perturbation waveform. Contrast to the Gaiting Impact Waveforms, the Gaiting Perturbation Waveforms are composed of the IMFs with frequencies lower than the half-step and full-step gaiting waveforms; hence, they correspond to users' body movement among steps.

### REFERENCES

[1] Jolliffe, Ian. Principal Component Analysis. John Wiley & Sons, 2005.
[2] A. Hyvarinen, J. Karhunen, E. Oja. Independent Component Analysis. John Wiley & Sons, 2001; Ch. 6—Principal Component Analysis and Whitening.
[3] Rehman, Naveed, and Danilo P. Mandic. “Multivariate empirical mode decomposition.” Proceedings of the Royal Society A: Mathematical, Physical and Engineering Science 466.2117 (2010): 1291-1302.
[4] Mandic, D. P. “Filter bank property of multivariate empirical mode decomposition.” Signal Processing, IEEE Transactions on 59.5 (2011): 2421-2426.

1. A method is disclosed that can decompose human gaiting patterns produced while walking, running, climbing up and down slopes or stairs or repetitive body and/or limb movements that change the positions and velocities of the center of gravity of those body parts into the components of three-dimensional (3D) Impact Waveforms, Gaiting Waveforms and Perturbation Waveforms from the 3D linear acceleration and 3D angular velocity signals captured by motion sensors attached to those body parts using a combination of Principal Component Analysis (PCA) and Multivariate Empirical Mode Decomposition (MEMD) along with the selection of Intrinsic Mode Functions (IMFs) produced based on their signal power distribution.

2. A method is disclosed to reduce the computational complexity of Multivariate Empirical Mode Decomposition (MEMD) by applying Principal Component Analysis (PCA) as a pre-processing step to ensure orthogonality among the components of 3D linear accelerations and 3D angular velocities as well as the unit-variance property of these components. This pre-processing is commonly referred to as the whitening step.

3. The method of claim 1 decomposes each orthogonal component of 3D linear accelerations and 3D angular velocities into Intrinsic Mode Functions (IMFs) with different signal power and instantaneous frequency distributions. Multiple Gaussian distributions will be fitted over the signal power distribution of these IMFs in order to separate them into high-power clusters with adjacent frequencies in each dimension and common frequencies across the three dimensions. These IMFs are combined to form the Gaiting Waveforms in each dimension.

4. The method of claim 1 also identifies a high-power Gaussian cluster of IMFs in each dimension with their instantaneous frequencies lying above the average instantaneous frequencies of the Gaiting Waveforms. In each dimension, these IMFs are combined to form the Impact Waveform in that dimension. These waveforms show the timing and the amplitude of decelerations/accelerations of the body parts as they impact a surface.

5. The method of claim 1 also identifies a relatively a high-power Gaussian cluster of IMFs (except the lowest frequency ones less than a full cycle) in each dimension with their instantaneous frequencies lying below the average instantaneous frequencies of the Gaiting Waveforms. In each dimension, these IMFs are combined to form the Perturbation Waveform in that dimension. These waveforms show the amplitude and relative time/phase of body movements among individual gaiting cycles.

6. Means and standard deviations of the amplitudes, the instantaneous frequencies, the relative phases of the Impact Waveforms, Gaiting Waveforms and Perturbation Waveforms in each dimension can be estimated using common statistical analysis techniques and treated as the signatures or features of human gaiting patterns.

7. The method of claim 2 enables Multivariate Empirical Mode Decomposition (MEMD) to compute the waveforms of Intrinsic Mode Functions (IMFs) along geodetic circles bisecting the high-dimensional unit sphere sparely instead of densely in uniform distribution. Consequently, the method can reduce the amount of computation significantly due to this reduction.
